(19) United States
(12) Patent Application Publication
(10) Pub. No.: US 2016/0002007 A1
(43) Pub. Date: Jan. 7, 2016

(54) WOOD CHIPPER HOOK

(71) Applicant: Yale Cordage Inc., Saco, ME (US)

(72) Inventor: Thomas L. Yale, W. Boothbay Harbor, ME (US)

(21) Appl. No.: 14/392,051

(22) PCT Filed: Feb. 18, 2014
(86) PCT No.: PCT/US14/00021

§ 371 Date: Jun. 15, 2015

(51) Int. Cl. B66C 1/14

(52) U.S. Cl. CPC B66C 1/14

(57) ABSTRACT

A hook for use in a wood chipper having a winch including a winch line, the hook being intended for use in securing the winch line to a load of branches, brush or logs so that the load can pulled by the winch line toward a feed mechanism in the wood chipper. The cutter blades in the wood chipper are made of steel. The hook comprises a unitary structure. The material from which the hook is made is selected from the group consisting of tin, glass fiber reinforced polymer, carbon fiber reinforced polymer, wood, ceramic, zinc alloy, lead and combinations thereof. The unitary structure in one version of the invention has a head portion, a neck portion extending down from the head portion and at least one arm extending out from the bottom of the neck portion and curving upward and inward toward the direction of the neck portion. In another version of the invention the unitary structure has a back wall portion, a front wall portion having an upper portion and a lower portion spaced from the upper portion, a top wall portion having a pair of openings and a bottom portion.

### FIELD OF THE INVENTION

The present invention relates generally to wood chippers of the type which include a winch for use in loading wood into a feed mechanism in the wood chipper and more particularly, to a hook for use in securing a winch line in the winch around a load of branches, brush or logs so that the load can be pulled by the winch line toward the feed mechanism in the wood chipper.

Wood chippers have been developed to reduce trees, limbs, branches and the like to wood chips. Such chippers are typically used by municipalities and tree services. Chipping eliminates environmental problems associated with burning and the chips can be used in a wide variety of applications such as mulch and fuel.

Basically, all wood chippers are of two broad types.

One type of wood chipper is the “drum type” wherein the chipper knives are carried on the circumferential wall of a cylindrical drum. An example of a drum type wood chipper is U.S. Pat. No. 5,005,620. In U.S. Pat. No. 5,005,620 which issued on Apr. 9, 1991 in the name of N. Mosey, there is disclosed a drum-type wood chipper having a chipper drum with knives mounted in openings with the drum wall. A chip basket is mounted within the drum behind each knife opening. The chipper knife is spaced from the drum wall at both the leading and trailing edges of the knife to define chip ingress and egress openings for the chip box. Cut chips pass into the chip box as the leading edge of the knife chips the infeed material; and the chips are carried by the box for subsequent discharge through the egress opening into a discharge chute. This patent is incorporated herein by reference.

The second type of wood chipper is the “disc-type” wherein the knives are carried radially on the face of a spinning disc. An example of such a chipper is illustrated in U.S. Pat. No. 3,861,602 issued Jan. 21, 1975, to Smith and entitled Brush Chipper. This patent is incorporated herein by reference.

In U.S. Pat. No. 6,446,889, which issued on Sep. 10, 2002, to M. D. Moore there is disclosed a wood chipper including a support frame, a cutter housing supported by the support frame, cutter mechanism positioned within the cutter housing, a feed housing supported by the support frame, and a feed mechanism positioned within the feed housing for feeding a log into the cutter mechanism. A feed table extends outward from the feed housing. The feed table is elevated above ground level and is positioned for supporting the log as the log is fed into the feed mechanism. The feed table has an outer edge located at a position opposite from the feed housing. The wood chipper also includes an elongated boom that is mounted on the feed housing and that extends over the feed table. The boom works in combination with a winch, including a flexible member that extends over the feed table via support provided by the boom. The boom includes an end guide over which the flexible member passes. The end guide is positioned such that when the winch pulls the log toward the table, the boom uses an end of the log to be lifted by the flexible member past the outer edge of the feed table and onto a top surface of the feed table. This patent is incorporated herein by reference.

In U.S. Pat. No. 5,692,548, which issued on Dec. 2, 1997, to J. T. B. Bourvers, et al. there is disclosed a drum chipper for chipping wood material. The drum chipper includes a chipping drum having a blade mounted at an opening formed through a circumferential surface of the drum. The drum includes an internal conical surface positioned for a chip to flow radially inwardly from the blade towards the conical surface and outwardly through an axial face of the drum. This patent is incorporated herein by reference.

Other U.S. references considered of interest include U.S. Pub. No. US 201210298783A1 published on Nov. 29, 2012, to S. J. Boliver, et al.; U.S. Pat. No. 7,121,488 which issued on Oct. 17, 2006 to M. E. Marriott, et al.; and U.S. Pat. No. 3,819,121 which issued on Jun. 25, 1994 to C. D. Rogers; and U.S. Pat. No. 2,634,062 which issued on Apr. 7, 1953 to W. O. Forman. All of these patent publications and patents are incorporated herein by reference.

In the past, wood chipper hooks have been made of either steel or aluminum and the cutter blades have been made of steel.

One of the problems wherein the load of wood to be fed into the wood chipper uses a winch line, such as a metal cable or a synthetic fiber rope, secured to the load by a hook, is that for one reason or another the worker does not remove the winch line and hook before the load of wood and the winch line and hook enter the wood chipper. When this happens, the hook, because of its physical properties, can damage one or more of the blades in the wood chipper which blades then have to be replaced. This can be very time consuming and costly.

Another problem with hooks in wood chippers is that they are somewhat difficult to attach to a load of wood.

Accordingly, it is an object of this invention to provide a wood chipper in which the cutting blades will not be damaged if during the operation of the wood chipper the hook used to secure a winch line around a load of wood comes into contact with one or more of the cutter blades.

It is another object of this invention to provide a wood chipper which includes a hook which functions as a sacrificial element rather than one or more of the cutter blades which become sacrificial members in the event that the hook comes into contact with one or more of the cutter blades during operation of the wood chipper.

### SUMMARY OF THE INVENTION

A hook for use in securing a winch line around a load of branches, brush or logs so that the load can be pulled toward a feed mechanism in the wood chipper, the hook according to this invention is made of a material such as tin, glass fiber reinforced polymer (normally known as fiberglass), carbon fiber reinforced polymer, wood, ceramic, zinc alloy, lead and combinations thereof. An example of a polymer is polycarbonate.

In one version of the invention the hook has a head portion, a neck portion extending down from the head portion and at least one arm extending out from the bottom of the neck portion and curving upward and inward toward the neck portion.

In another version of the invention, the hook comprises a back wall portion, a front wall portion having an upper portion and a lower portion spaced from the upper portion, a top wall portion having a pair of holes and a bottom portion.

In both versions of the invention, as described above, the hook because of the materials from which it is made will chip off before one or more of the knives in the wood chipper are damaged.

Thus, the wood chipper hook in effect becomes a sacrificial member which is much more economical to replace than a chipper knife.

Various features and advantages will appear from the description to follow. In the description, reference is made to the accompanying drawings which form a part thereof, and in which is shown by way of illustration versions for practicing this invention. These versions will be described in sufficient detail to enable those skilled in the art to practice the invention. It is to be understood that other versions may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a simplified pictorial view of a wood chipper including a hook according to this invention;

FIG. 2 is an enlarged perspective view of the hook shown in FIG. 1 as it is attached to a winch line;

FIGS. 3 and 4 are views showing how the hook and winch line is used to secure the winch line around a log for movement toward the wood chipper shown in FIG. 1;

FIG. 5 is an enlarged plan view from the front of another version of the hook according to this invention; and

FIGS. 6 through 10 are views showing how the hook shown in FIG. 5 is used to secure a winch line around a log for movement toward the wood chipper shown in FIG. 1.

### DETAILED DESCRIPTION OF PREFERRED EMBODIMENTS

Wood chipper manufacturers often sell chippers with winches and winch lines installed. The winches are already equipped with steel hooks. In effect, the chipper and winch system are predisposed to encounter abuse and potential damage of the expensive steel cutting blades because of the brisk pace normally attributable to the workers feeding the chipper with wood via the winch. As they work they adopt a certain routine which tends to be interrupted by the wide variety of shapes and sizes of the various bundles the hook is used to wrap the winch line around and grab onto. In the process of unhooking the hook from the winch line it is not uncommon to witness the sudden entanglement of the line with the feeder mechanism at the entrance to the chipper. This happens, for example, when an errant branch emerging from the bundle exceeds the bulk of the bundle in its proximity to the feeder. Workers must then react quickly, and at risk to injury, to untangle the line so as to prevent it from being drawn into the chipper.

A sacrificial hook, as described herein, will reduce the urgency on the part of the worker to untangle the line and branch and thus enable a more deliberate, thoughtful, and thus safer act with less preoccupation for harming the chipper, a very expensive machine.

The sacrificial nature of the hook is defined by its comparatively weaker material, i.e. plastic or wood, etc. which will be chopped up without harming the chipper's steel blades.

It is not enough to say the hook is softer, as there are soft and hard steels all of which in sufficient quantity would harm the blades whether or not they are technically softer than the blades. The cutting blades are likely made of medium to high carbon steel. They may even be made of stainless steel which is not as hard but will not rust, which is an obvious benefit to the user. There are metallic materials, such as soft aluminum, white metal, zinc, and others which may be choppable by the blades without harm. However, establishing the threshold of blade damage depends on many factors, including blade fragility or susceptibility to fracture. This is related to the gage and cross-section of the blade as much as the material. A long thin blade, even if very hard, may fail when chopping a softer object because the blade's bending resistance is insufficient to prevent it from cracking apart. Such would be the case with the already mentioned steel hook. It is likely softer metallurgically, but it has significant mass and structure. Thus, the hook would suffer a serious dent or two but nonetheless survive the blades as they crack and bend apart. The hook of this invention will be significantly softer than, and not nearly as hard as the blade. When impacted by the sharp blade, the hook will tend to fracture (break apart) with minimal ductility. The stress on the blades will be significant but not sufficient to inflict damage.

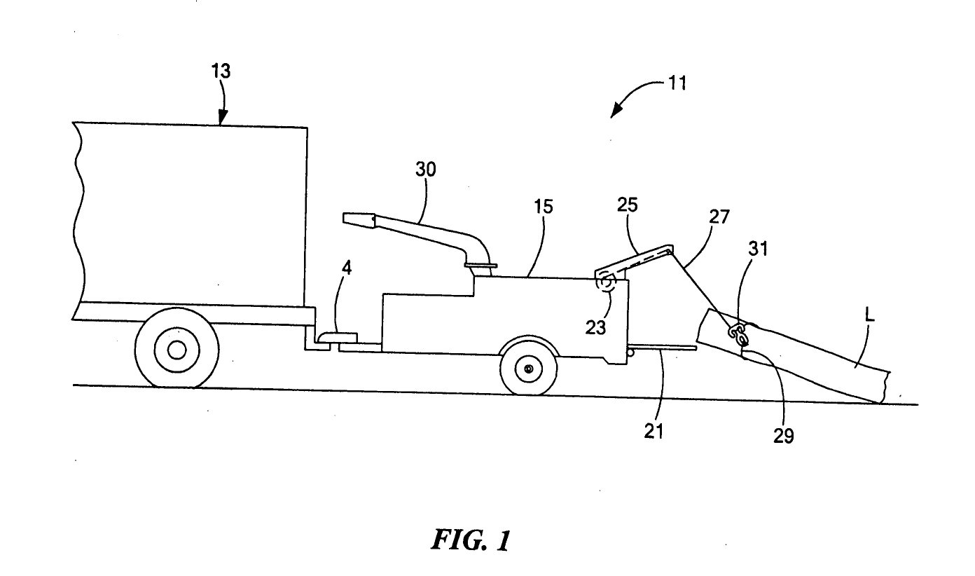

Referring now to the drawings, there is shown in FIG. 1 a simplified pictorial view of a wood chipper according to this invention and identified by reference number 11. For simplicity, some parts of wood chipper 11 are not shown.

Wood chipper 11 includes a dump truck 13 fixedly attached by a trailer hitch 14, to a cutter housing 15, a drum D having a plurality of cutter blades CB inside cutter housing 15, a chipper deck 21 attached to cutter housing 15, a winch 23 mounted on top of housing 15, an extension 25 attached to winch 23, a winch line 27 attached at one end to the drum D and extending out through extension 25 to the outer end 29 of winch line 27, a discharge chute 30 and a hook 31 for securing winch line 27 around a log L for movement into wood chipper 11.

The material in hook 31 is selected from the group consisting of tin, glass, fiber reinforced polymer, wood, ceramic, zinc alloy, lead, carbon fiber reinforced polymer and combinations thereof.

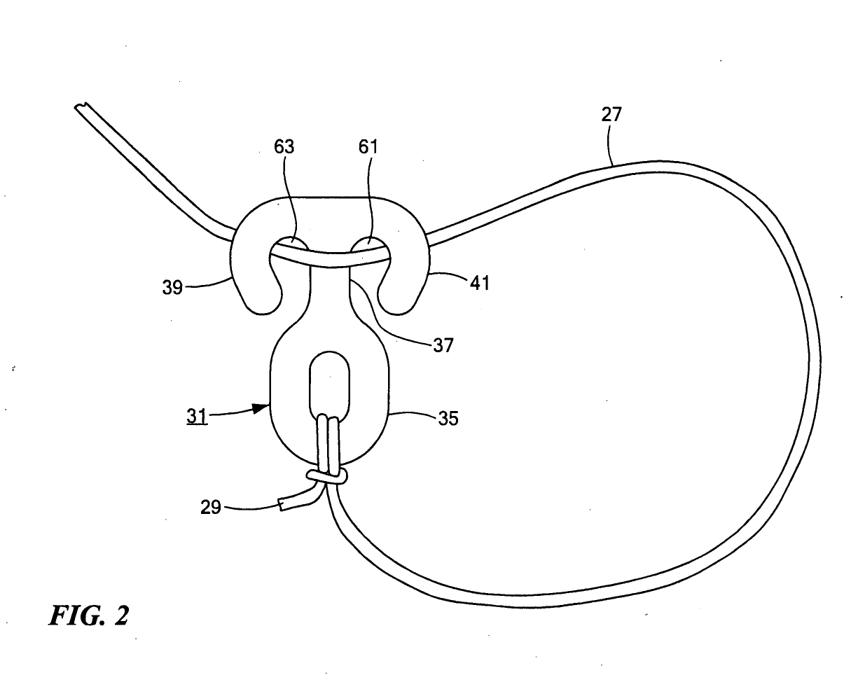

Hook 31, as can be seen in FIG. 2, comprises a unitary structure having an annular head portion 35, a neck portion 37, and a pair of arms 39 and 41 extending out from the bottom of neck portion 37 and curving upward and inward in the direction of neck portion 37.

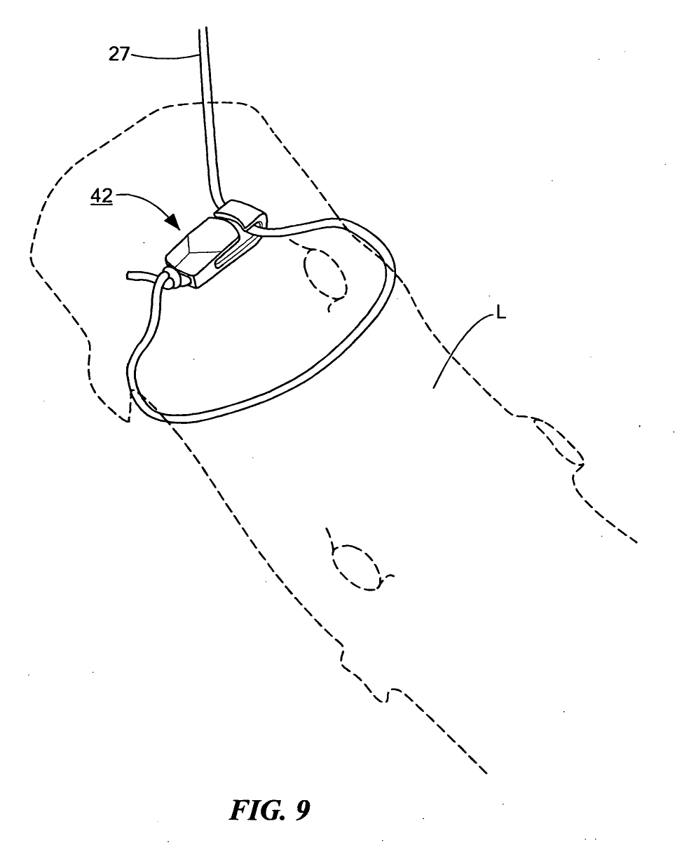

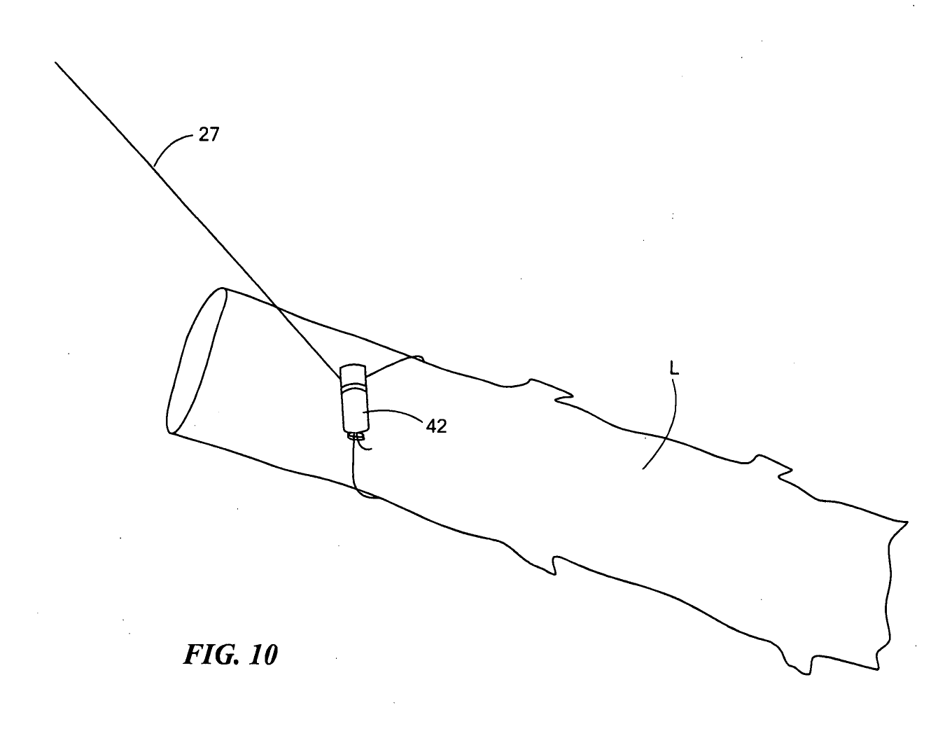

In another version of the invention hook 42 as shown in FIGS. 6 through 10 comprises a unitary structure, the material in the hook being selected from the group consisting of tin, glass fiber reinforced polymer, wood, a ceramic, zinc alloy, lead, carbon fiber reinforced polymer and combinations thereof. The unitary structure has a back wall portion 43, a front wall portion 45 having an upper portion 47 and a lower portion 49 spaced from upper portion 47, a top wall portion 51 having a pair of holes 53 and 55 and a bottom portion 57.

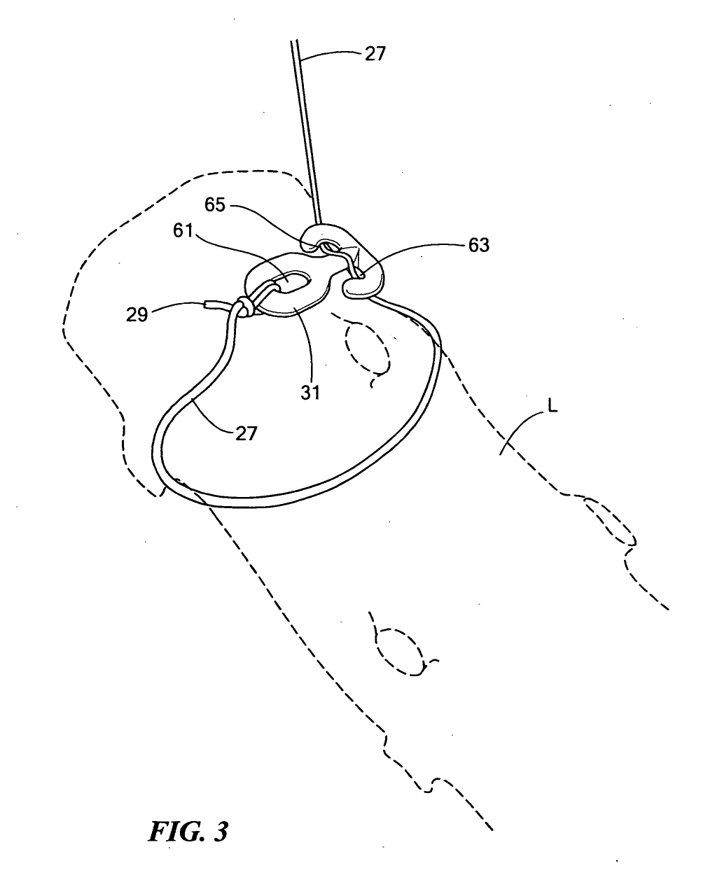

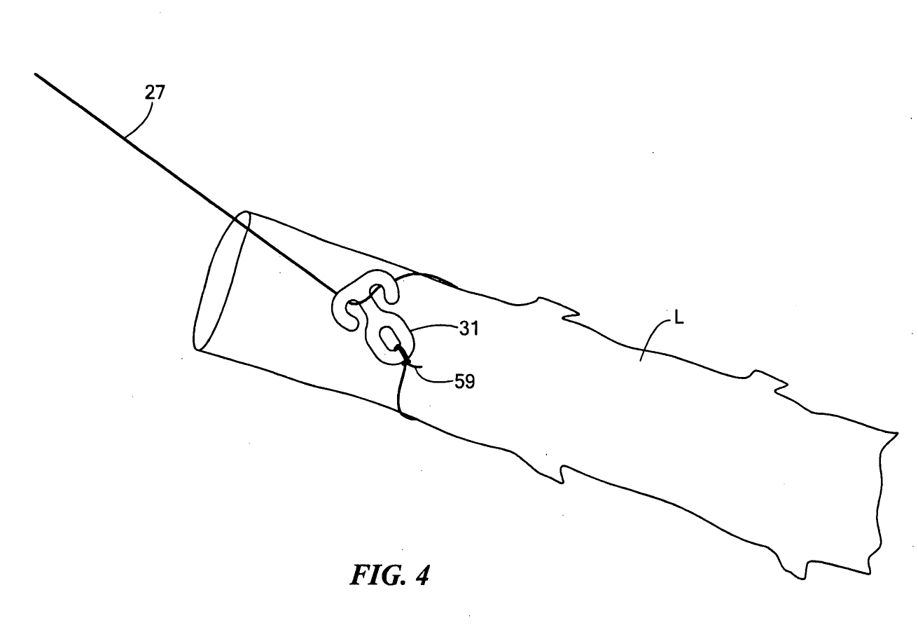

Referring now back to FIGS. 2 through 4, there is shown a series of views depicting how chipper hook 31 is attached to winch line 27. First, outer end 2 of winch line 27 is passed through opening 61, and then tied in a knot about itself. Then winch line 27 is moved underneath and around the pile of logs in this case a single log and extended through openings 63 and 65 in chipper hook 31 to secure winch line 27 to log L so that the log L can be moved toward winch 23.

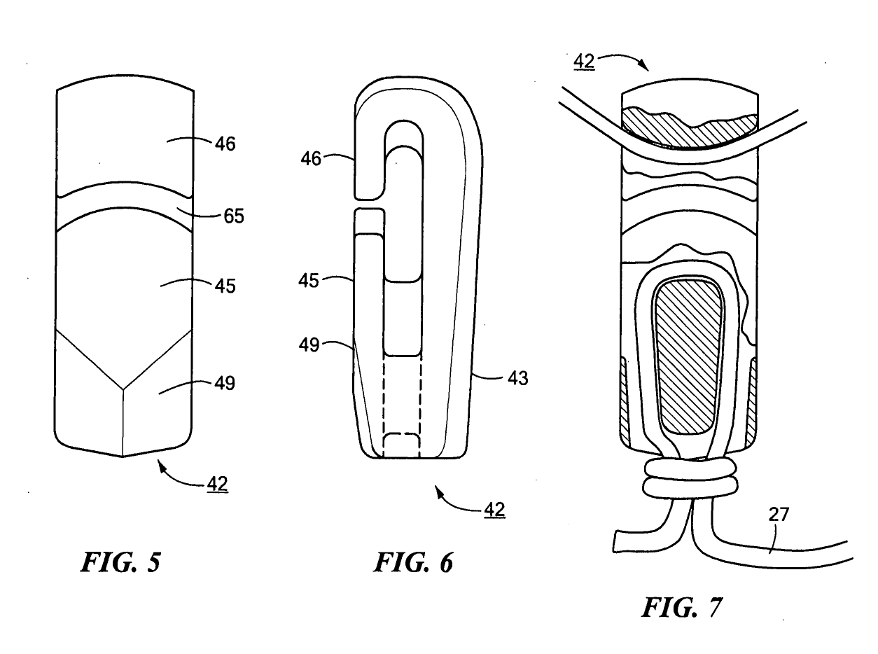

In FIGS. 5-10, the material in hook 42 is selected from the group consisting of a tin, glass, fiber reinforced polymer, wood, ceramic, zinc alloy, lead, carbon fiber reinforced polymer and combinations thereof.

As can be seen, FIG. 5 is a front view of hook 42 and FIG. 6 is a right side view of hook 42. Also, FIG. 7 is broken away in part to clearly show the path of winch line 27 through hook 27 in securing winch line 27 around log L.

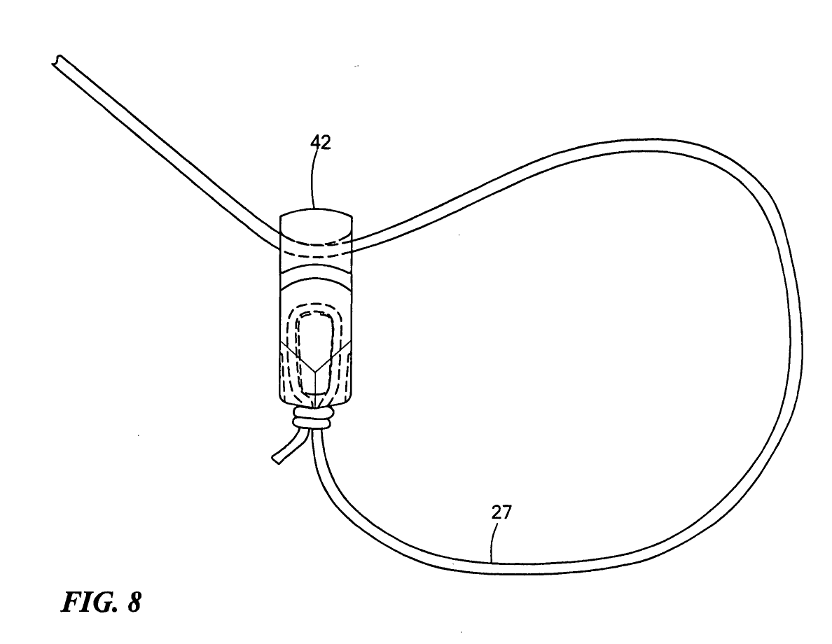

In securing winch line 27 around log L outer end 29 of winch line 27 is pushed into hook 42 through opening 59, pushed around guard 61 and exits hook 42 through opening 63 and tied around itself to secure winch line 27 to hook 42. Then winch line 27 is pushed around log L through arcuate slot 65. A more detailed view is shown in FIGS. 8 through 10.

What is claimed is:

1. A hook for use in a wood chipper for securing a winch line in the wood chipper around a load of branches, brush or logs so that the load can be pulled by the winch line toward a cutter mechanism in the wood chipper, the cutter mechanism having at least one cutter blade of steel, the hook comprising a material that will not damage the cutter blades in the cutter mechanism if during operation of the wood chipper the hook comes into contact with one or more of the blades, wherein the hook will be sacrificed without damaging any of the blades in the cutter mechanism, the material in the hook being selected from the group consisting of wood, ceramic, tin, glass fiber reinforced polymer, carbon fiber reinforced polymer, zinc alloy, lead and combinations thereof.

2. The hook of claim 1 wherein the hook is shaped to include a head portion, a neck portion and at least one arm.

3. The hook of claim 2 wherein there are two arms extending out from the neck portion, one on each side of the neck portion.

4. The hook of claim 1, wherein the hook is shaped to include a back wall portion, a front wall portion having an upper portion and a lower portion spaced from the upper portion, a bottom wall portion having a pair of holes and a channel in the upper portion of the front wall.

5. A hook for use in securing a line around a load, the material in the hook being selected from the group consisting of wood, ceramic, tin, glass fiber reinforced polymer, carbon fiber reinforced polymer, zinc alloy, lead and combinations thereof.

6. The hook of claim 5 wherein the hook is shaped to include a head portion, a neck portion and a least one arm.

7. The hook of claim 6 wherein there are two arms extending out from the neck portion, one on each side of the neck portion.

8. The hook of claim 5, wherein the hook is shaped to include a back wall portion, a front wall portion having an upper portion and a lower portion spaced from the upper portion, a bottom wall portion having a pair of holes and a channel in the upper portion of the front wall.
